(19) United States
(12) Patent Application Publication
(10) Pub. No.: US 2007/0227934 A1
(43) Pub. Date: Oct. 4, 2007

(54) Color matching system for artificial nails and polish colors

(75) Inventors: Joseph Michael Fracassi, Lake Forest, CA (US); Jeanine Catherine Coppola, Irvine, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Pacific World Corporation, Lake Forest, CA (US)

(21) Appl. No.: 11/390,580

(22) Filed: Mar. 28, 2006

(51) Int. Cl. B65D 69/00; B65D 85/00; G09F 1/00; A47F 10/02

(52) U.S. Cl. 206/581; 206/459.5; 186/57; 40/124.01

(57) ABSTRACT

A color matching system for the identification of desirable nail color configuration for a given user's characteristics, comprising a combination of a rendition comprising at least one user identifier and at least one corresponding nail color configuration identifier to be associated with said user identifier, and at least one of a bottle of nail polish and/or a plurality of artificial nails corresponding to said nail color configuration identifier. The at least one user identifier may be in the form of either graphic or written identification of user characteristics such as skin tone, user foundation color, and user ethnicity. The at least one corresponding nail color configuration identifier comprises an identifier unique to one or a group of nail colors, and may be one or more of an identifier such as a name, identifying number, type, or indicia of a nail polish color, an artificial nail, a product decoration, product number, package or package insert color or shape, or graphic representation of color.

### FIELD OF THE INVENTION

The present invention relates to human nail decorations, and more specifically the invention pertains to the packaging and selection of preformed artificial nails and nail color for placement over and adherence to human nails.

### BACKGROUND OF THE INVENTION

Well manicured hands and feet present a polished, professional appearance. A major factor in such a manicured appearance is the presentation of ones nails. Many individuals are unable or unwilling, however, to grow or maintain healthy nails of a desired length or uniformity. Alternately, they may not have the time, skill, or financial wherewithal to maintain or obtain a more finished appearance that may result from well manicured and/or polished nails. As a result, entire industries have developed around the artificial supplementation and enhancement of natural nails.

Such enhancements may range from manicuring and polishing of natural fingernails to individually building artificial nails on the natural nail and a tip and/or nail form from an acrylic powder and liquid which chemically bond to the nail surface as the artificial nail is built. Prior to application of an acrylic nail, a bonding agent or primer is applied directly to the natural nail. Typically, a form is placed subjacent the free edge of the user's finger nail or a tip portion is applied to the finger nail when the user desires a lengthening of the natural nail. Acrylic nails are built up and formed directly on the user's own finger nail and the form and/or tip from a mixture of an acrylic liquid (typically methacrylate ester) and an acrylic powder (typically methacrylate copolymer). The operator then dips an applicator brush in the liquid and powder are mixed together to provide a flowable acrylic resin that is repeatedly brushed over the length of the nail and tip and/or form to develop an acrylic nail. The acrylic literally bonds with the user's own fingernail. Although kits are available for home fabrication of such acrylic nails, acrylic nails are typically formed in salons. While such acrylic nails are relatively durable, the process of fabricating acrylic nails is time consuming and can be expensive. The use of acrylic nails also requires regular maintenance as the user's natural nails grow out. Finally, because the acrylic bonds to the nail surface, removal of such acrylic nails from the user's natural nails requires particular chemicals or mechanically prying the developed acrylic nail from the natural nail surface, and can still result in damage to the natural nail.

So-called gel tips are similarly built up directly on the user's natural nail, generally following the placement of a tip. The tip itself may be adhered to the natural nail using an adhesive or a fluid gel overlay, typically an ethyl cyanoacrylate, strengthening the line between the natural nail and artificial tip if desired. The fluid gel overlay is then brushed over the entire nail and tip, if utilized. Optionally, the wet nail is then dipped into a powder substance (typically an ethyl methacrylate), and this process repeated. Finally, a gel activator, typically an ethyl acetate, is then applied, generally by brush or spray, to set the gel overlay. The finished nail is then buffed smooth.

Between these two extremes (of time-consuming manicures and the creation of acrylic or gel nails directly on the user's natural nail) are preformed, artificial nails that are glued or otherwise bonded to a person's own naturally occurring fingernails. Such nails are readily available to a wide range of users through drug and department stores. Such preformed artificial nails may be clear or opaque, and/or prepolished and/or decorated to provide the desired appearance. Preformed artificial nails provide users with a relatively quick and economical means by which to provide a polished, manicured appearance.

Such preformed artificial nails are traditionally made of plastic materials such as acrylonitrile butadiene styrene (ABS), polyethylene or polypropylene and are secured to the user's nail with an adhesive. The preformed nails may be removed using commonly available acetone nail polish remover, which dissolves the adhesive to separate the preformed nail from the natural nail. Preformed artificial nails may either be polished or decorated once applied, or the preformed nail may include color and/or other decoration prior to application. For the purposes of this disclosure, the term “artificial nail” shall mean an artificial nail that is molded, by injection molding or other method of fabrication, into a complete, discrete nail that may then be secured to the user's natural nail, rather than a nail that is formed directly on the user's nail, as with the acrylics and gels described above.

Preformed artificial nails are provided in a variety of lengths to extend the free edge of the user's nail from a relatively short, sportier amount to relatively long, glamorous lengths. Moreover, the free edge of such artificial nails is provided in a variety of shapes to meet the user's preference generally as to how one might file one's own nails. The distal free edge may have any of various lengths and shapes, such as oval, square, or flared, depending upon the desired look. Additionally, to further simulate a natural fingernail, the artificial nail is typically formed with a curvature between a first side edge and a second side and a curvature between the proximate and distal edges.

Preformed artificial nails are traditionally supplied in either a full nail form or a nail tip form. As indicated by the name, full nails simulate a complete nail, including nail bed and free edge and are adhered thereto, covering the entire nail, including the nail bed and free edge of the nail. The proximate edge is shaped to be disposed substantially adjacent or abut against the cuticle of the finger. In contrast, nail tips do not simulate the complete nail, but, rather, only the free edge and, typically, a small extended portion to cover only a portion of the nail bed in order to facilitate attachment to the nail. In use, nail tips are secured to the edge of the nail bed adjacent the free edge and the tip only.

While artificial nails and polishes provide convenient and economical ways to enhance the appearance of one's natural nails, the wide selection of artificial nails and nail colors and combinations available can be overwhelming to the user. No only are given nail colors typically more complementary certain tones evidenced by the user's own features, but particular colors may not be particularly suited for all possible users. While this phenomenon is most apparent in the use of so-called French manicure-type artificial nails and French manicure polishes inasmuch as the French manicure is generally intended to simulate a very well manicured natural-looking nail, it is likewise applicable to a wide range of nail colors. Unfortunately, however, a potential user is provided no guidance in the selection of the most appropriate nail colors for the user's own features among the literally hundreds of artificial nails and nail colors available on the market today.

### BRIEF SUMMARY OF THE INVENTION

The invention comprises an arrangement that facilitates user identification of desirable nail color configuration. The arrangement comprises a combination of a rendition comprising at least one user identifier and at least one corresponding nail color configuration identifier to be associated with said user identifier, and at least one of a bottle of nail polish and/or a plurality of artificial nails corresponding to said nail color configuration identifier. The rendition may be provided on the product or product packaging itself, or a rendition separate from the product itself, such as a chart, pamphlet, display board or card. The at least one user identifier may be in the form of either graphic or written identification of user skin tone, user foundation color, and/or user ethnicity.

The at least one corresponding nail color configuration identifier comprises an identifier unique to one or a group of nail colors. The nail color configuration identifier may be, for example, one or more of a color name, identifying product number and/or letter or the like, type, graphic indicia, product decoration, package or package insert color or shape, or graphic representation of color, as, for example, by a sample of the color or an artificial nail displaying such color or configuration. The nail color configuration identifier may be for a single such color or for a group of colors. The nail color configuration identifier may further include an arrangement for sampling or trying a sample nail on the user's natural nail by allowing the user to place a finger under or adjacent a sample artificial nail displaying such color or configuration.

Thus, the invention provides invaluable guidance to the potential user as to the colors or configurations of nail polish color or artificial nails that would be appropriate for the user's unique characteristic tone or tones. The combination of the rendition and the actual product in near proximity allows the potential user to rapidly narrow and identify desirable product from the voluminous polish shades and artificial nails available.

These and other objects and advantages of the invention will be apparent to those skilled in the art upon reading the following summary and detailed description and upon reference to the drawings.

### BRIEF DESCRIPTION OF THE DRAWINGS

FIG. 1 is a perspective view of a color matching system constructed in accordance with teachings of the invention.

FIG. 2 is a front elevational view of an alternate embodiment of a rendition for a color matching system constructed in accordance with teachings of the invention.

FIG. 3 is a front elevational view of another alternate embodiment of a rendition for a color matching system constructed in accordance with teachings of the invention.

FIG. 4 is a perspective view of an alternate embodiment of a color matching system constructed in accordance teachings of the invention.

FIG. 5 is a perspective view of another alternate embodiment of a color matching system constructed in accordance teachings of the invention.

FIG. 6 is a perspective view of another alternate embodiment of a color matching system constructed in accordance teachings of the invention.

### DETAILED DESCRIPTION OF THE INVENTION

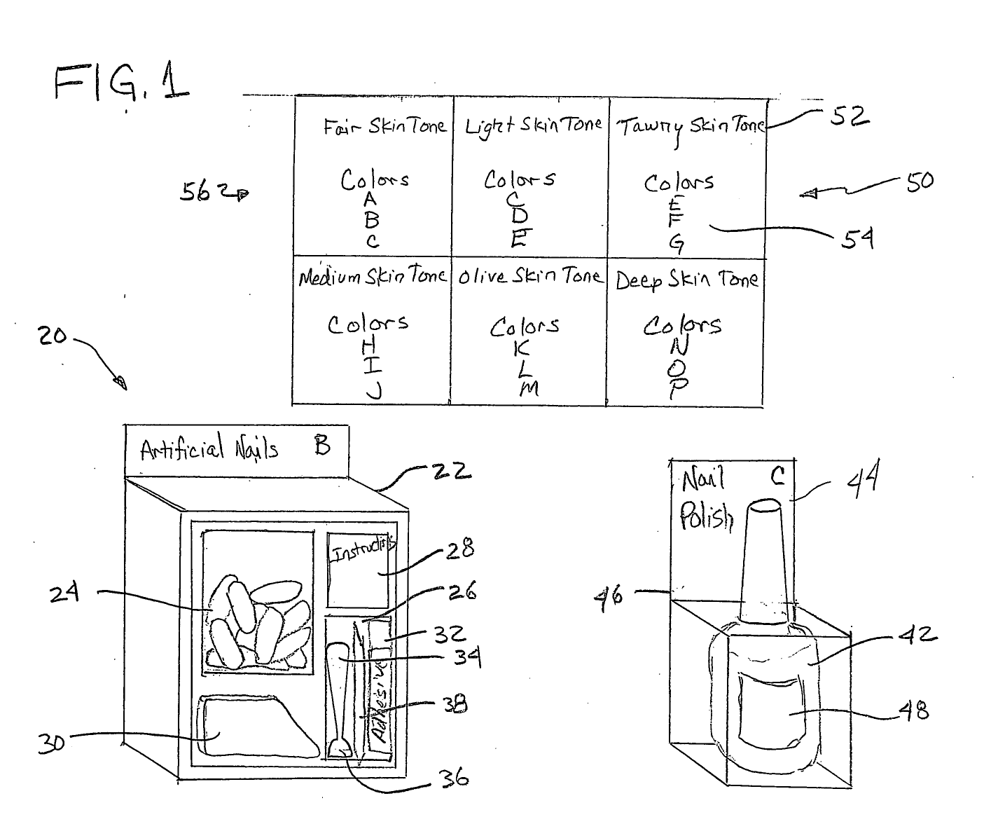

Turning now to the drawings, wherein like reference numbers refer to like elements, there is illustrated in FIG. 1 a nail kit 20 comprising a package 22 containing a plurality of preformed artificial nails 24, which may be of any appropriate design. The package 22 may additionally contain a package insert 26, instructions 28, and/or one or more of additional products, such as, for example, an emery board or roughened surface 30 for filing, liquid adhesive 32, peel-off adhesive pads, and/or preplaced tacky adhesive for bonding the artificial nails to the purchaser's natural fingernails, a cuticle pusher 34, an application tool 36, or a grooming stick 38, such as a rosewood stick. Also shown in FIG. 1 is a bottle of nail polish 42. The bottle of nail polish 42 includes a label 44, which may be in the form of an attached sheet, coupled tag, or printing directly on the bottle, and, in this embodiment, a package 46 as well as a label 48.

In accordance with the invention, there is provided an arrangement that facilitates user identification of selected, appropriate nail color configuration(s). The arrangement comprises a rendition 50 comprising at least one user identifier 52 and at least one corresponding nail color configuration identifier 54 to be associated with the user identifier, in combination with at least one of the bottle of nail polish 42 and/or the package 22 of the plurality of artificial nails 24 corresponding to the nail color configuration identifier 54.

The rendition 50 may be provided at any appropriate location. In the embodiment of FIG. 1, there is shown a display board 56 having a rendition 50 that includes a plurality of exemplary user identifiers 52, along with corresponding exemplary nail color configuration identifiers 54. In the illustrated embodiment, the at least one user identifier 52 is a written identification, here, of user skin tone. It will be appreciated, however, that the user identifier 52 may be in the form of either written identification or graphic representation, such as a color template or photograph. Further, the user identifier 52 may reference any feature that represents an individual or group of individuals, such as, for example, user skin tone, user foundation color, and user ethnicity.

Similarly, the at least one corresponding nail color configuration identifier 54 comprises an identifier unique to one or a group of nail colors. In the illustrated embodiment of FIG. 1, the nail color configuration identifier refers to a number of colors, each identified by a letter. It will be appreciated, however, that any appropriate color configuration identifier 54 or combination of color configuration identifiers 54 may be utilized, such as, for example a color name, identifying product or color number and/or letter or the like, type, graphic indicia, product decoration, package or package insert color or shape, or graphic representation of color, as, for example, by a sample of the color or an artificial nail displaying such color or configuration.

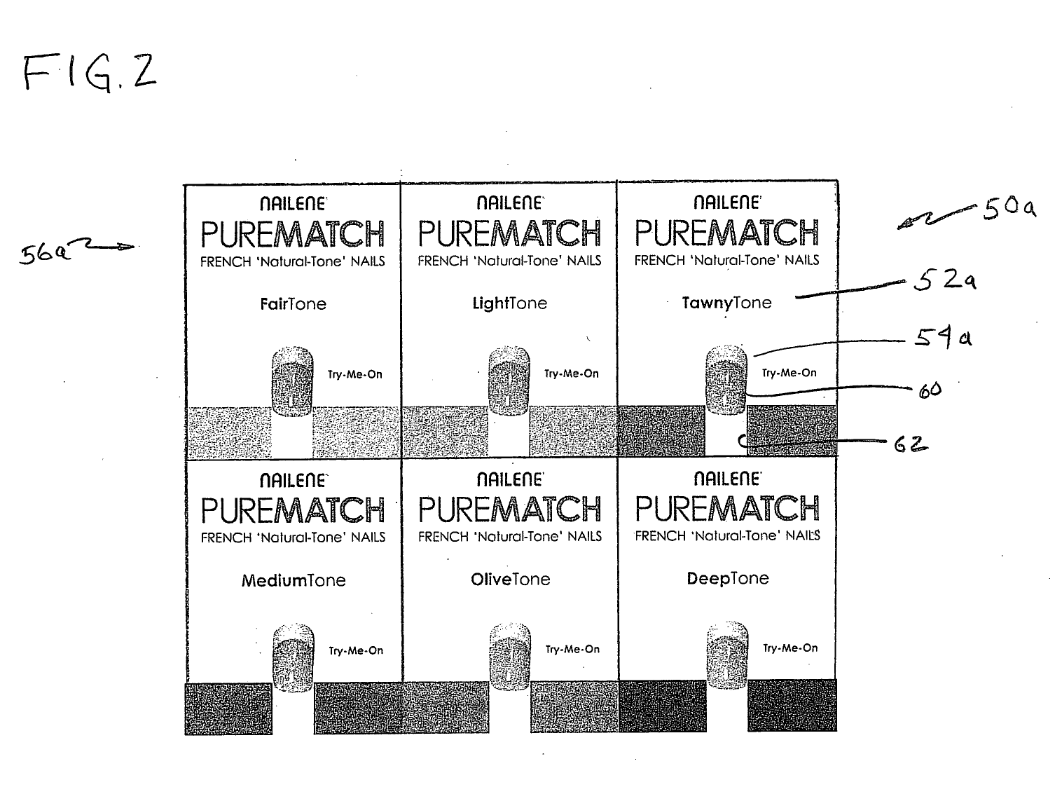

The nail color configuration identifier 54 may further include an arrangement for sampling or trying a sample nail on the user's natural nail by allowing the user to place a finger proximate to or under a sample artificial nail displaying such color or configuration. As shown in the display board 56a of FIG. 2, the rendition 50a includes a descriptive user identifier 52a of skin tone, as well as an artificial nail sample 60 as a color configuration identifier 54a. Here, the sample 60 itself may be utilized as an interactive display in that the user may place her own finger in a slot 62 that allows the user to position the sample 60 adjacent the user's natural nail to observe the color adjacent the user's own skin tone and envision the product color or artificial nail during wear. It will be appreciated that, in this embodiment, the user identifier 52a may likewise be utilized as a color configuration identifier in addition to the color sample 54a.

As shown in FIG. 1, there may be some overlap in the color configuration identifiers 54 and the user identifiers 52, with certain color configuration identifiers 54 being applicable for more than a single user identifier 52. Likewise, a single user identifier 52 may have multiple color configuration identifiers 54 associated therewith.

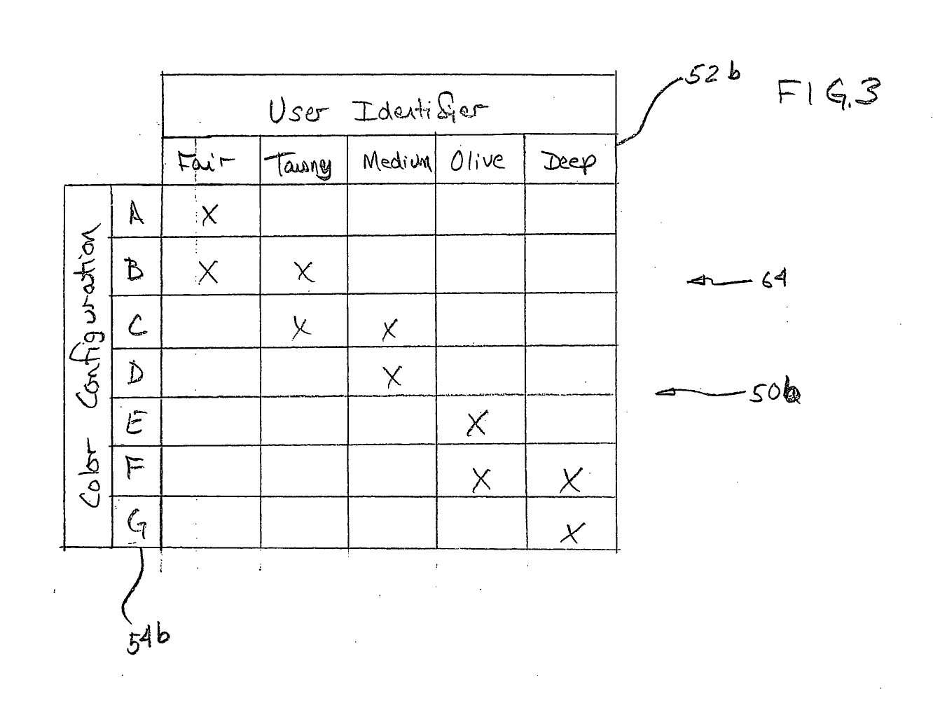

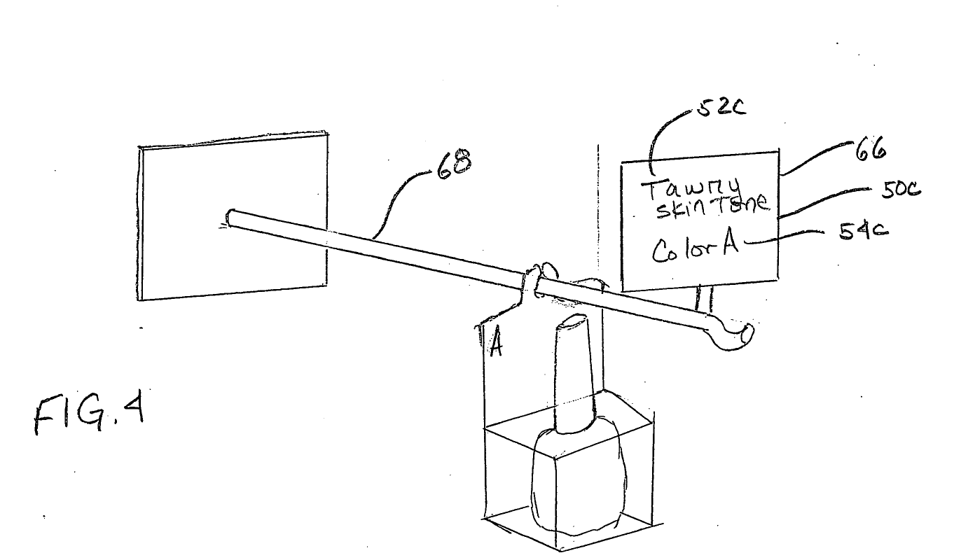

While the renditions 50, 50a of FIGS. 1 and 2 illustrate display boards 56, 56a with individual panel portions for each of the user identifiers 52, 52a, the rendition may take any appropriate form, such as, for example, a chart 64 shown in FIG. 3, or the product tab marker 66 at the product hanger 68 shown in FIG. 4. Further possible embodiments of a rendition include, for example, a separate pamphlet or card, or the like.

While the rendition 50 has been illustrated as separate from the product, alternately, either the product 24, 42 or product packaging 20, 44, 46 itself or an enclosure may include the rendition. For example, as shown in FIG. 5, the rendition 50d may be associated directly with the product, here, artificial nails 24d. In FIG. 5, the user identifier 52d is provided on the product package 22d, although the user identifier may likewise or alternately be provided on an enclosure in the package 22d, such as the instructions 28d or product insert 26d that is preferably visible from outside of the package 22d. While the package 22d in this embodiment is likewise provided with a graphic identification of the color configuration identifier 54d, the color configuration may alternately be solely in the form of the displayed artificial nails 24d.

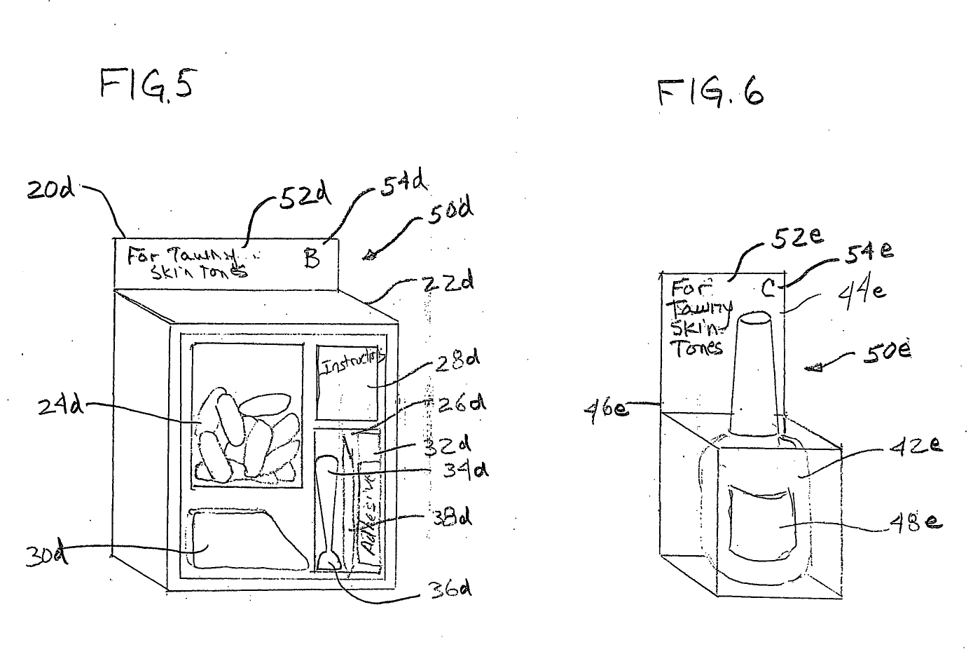

Similarly, in FIG. 6, the rendition 50e is associated with nail polish 42e as the product. Here, the user identifier 52e is likewise provided on the product package 44e, although the user identifier may likewise or alternately be provided on an enclosure in the package 44e, or on the product 42e itself in the form of a label 48e, either on the bottle or coupled to the bottle. While the package 44e in this embodiment is likewise provided with a graphic identification of the color configuration identifier 54e, the color configuration may alternately be solely in the form of the displayed color of the nail polish 42e itself.

In summary, the invention provides a rendition 50 of at least one user identifier 52 and at least one coordinated product color configuration identifier 54. The product color configuration identifier 54 corresponds to an actual product in the form of at least one of a plurality of artificial nails 24 or a nail polish 42. In this way, the invention guides the potential user as to the colors or configurations of nail polish color or artificial nails that would be appropriate for the user's unique characteristic tone or tones. The combination of the rendition and the actual product in near proximity allows the potential user to rapidly narrow and identify desirable product from the voluminous polish shades and artificial nails available.

While this invention has been described with an emphasis upon preferred embodiments, variations of the preferred embodiments can be used, and it is intended that the invention can be practiced otherwise than as specifically described herein. Accordingly, this invention includes all modifications encompassed within the spirit and scope of the invention as defined by the following claims.

All of the references cited herein, including patents, patent applications, and publications, are hereby incorporated in their entireties by reference.

We claim as our invention:

1. An arrangement for the user identification of desirable nail color configuration, the arrangement comprising:
a rendition comprising at least one user identifier, and at least one corresponding nail color configuration identifier to be associated with said user identifier, and
at least one of a bottle of nail polish and/or a plurality of artificial nails corresponding to said nail color configuration identifier.

2. The arrangement of claim 1 comprising the plurality of artificial nails, said arrangement further comprising a package having an inside and an outside, said plurality of artificial nails being disposed inside said package, and wherein the rendition is visible from at least one of the outside of the package or outside of said bottle.

3. The arrangement of claim 1 wherein the user identifier comprises at least one of user skin tone, user foundation color, and user ethnicity.

4. The arrangement of claim 1 wherein the corresponding nail color configuration identifier comprises at least one of a color name, identifying product number and/or letter, type, graphic indicia, product decoration, package or package insert color or shape, sample of color, and/or graphic representation of color.

5. The arrangement of claim 1 wherein the arrangement includes a board.

6. The arrangement of claim 1 wherein the arrangement includes an artificial nail sample displaying said nail color configuration identifier.

7. The arrangement of claim 1 wherein the arrangement includes an interactive presentation of artificial nails.

8. The arrangement of claim 1 further comprising at least one of a display board, a pamphlet, a hanger tag, or a card, and wherein the rendition is provided on said display board, pamphlet, hanger tag, or card.

9. The arrangement of claim 1 wherein at least one of the bottle of nail polish and/or plurality of artificial nails and/or packaging associated said at least one bottle of nail polish and/or plurality of artificial nails comprises said corresponding nail color configuration identifier.

10. The arrangement of claim 9 wherein said nail polish or said artificial nails comprises a said corresponding nail color identifier.

11. The arrangement of claim 9 wherein said at least one of the bottle of nail polish and/or plurality of artificial nails and/or packaging associated said at least one bottle of nail polish and/or plurality of artificial nails comprises said rendition.

12. The arrangement of claim 1 wherein said corresponding nail color configuration corresponds to a group of least two different bottles of nail color, two different packages of artificial nails, or a package of artificial nails and a bottle of nail color.

13. The arrangement of claim 2 wherein the user identifier comprises at least one of user skin tone, user foundation color, and user ethnicity.

14. The arrangement of claim 2 wherein the corresponding nail color configuration identifier comprises at least one of a color name, identifying product number and/or letter, type, graphic indicia, product decoration, package or package insert color or shape, sample of color, and/or graphic representation of color.

15. The arrangement of claim 2 wherein the arrangement includes a board.

16. The arrangement of claim 2 wherein the arrangement includes an artificial nail sample displaying said nail color configuration identifier.

17. The arrangement of claim 2 wherein the arrangement includes an interactive presentation of artificial nails.

18. The arrangement of claim 2 further comprising at least one of a display board, a pamphlet, a hanger tag, or a card, and wherein the rendition is provided on said display board, pamphlet, hanger tag, or card.

19. The arrangement of claim 2 wherein at least one of the plurality of artificial nails and/or packaging associated with said plurality of artificial nails comprises said corresponding nail color configuration identifier.

20. The arrangement of claim 1 wherein said corresponding nail color configuration corresponds to a group of least two different packages of artificial nails.
